(19) United States
(12) Patent Application Publication
(10) Pub. No.: US 2025/0094150 A1
(43) Pub. Date: Mar. 20, 2025

(54) AI MODEL FOR SYNTHESIZING SOFTWARE FROM A USER PROMPT

(71) Applicant: Durable AI, Louisville, CO (US)

(72) Inventors: Michael Kasper, Westminster, CO (US); Calvin Smith, Louisville, CO (US); Fernando Nobre, Denver, CO (US); Nima Keivan, Boulder, CO (US); Theodore Hoff, Broomfield, CO (US)

(21) Appl. No.: 18/889,716

(22) Filed: Sep. 19, 2024

Related U.S. Application Data
(60) Provisional application No. 63/583,780, filed on Sep. 19, 2023.

(51) Int. Cl. G06F 8/60; G06F 8/10; G06F 8/35

(52) U.S. Cl. CPC G06F 8/60; G06F 8/10; G06F 8/35

(57) ABSTRACT

Systems and methods for synthesizing software application code for a software application. An example method includes receiving, from a user device, an initial prompt comprising a natural language description of a plurality of specification elements defining a functionality and a scope of a software application; synthesizing software application code for the software application by processing the initial prompt through a synthesis model, wherein the synthesis model is trained to: generate, based on the initial prompt, a specification document comprising the specification elements; and generate the software application code for the software application by determining a bidirectional mapping between the software application code and the specification elements; and deploying, to a deployment platform, the generated software application code for execution.

### SUMMARY

This application claims priority to U.S. Provisional Patent App. No. 63/583,780, filed Sep. 19, 2023, the entire contents of which are herein incorporated by reference.

### SUMMARY

In one aspect, disclosed herein are systems and methods for synthesizing software application code for a software application. An example method includes receiving, from a user device, an initial prompt comprising a natural language description of a plurality of specification elements defining a functionality and a scope of a software application; synthesizing software application code for the software application by processing the initial prompt through a synthesis model, wherein the synthesis model is trained to: generate, based on the initial prompt, a specification document comprising the specification elements, generate the software application code for the software application by determining a bidirectional mapping between the software application code and the specification elements; and deploying, to a deployment platform, the generated software application code for execution.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more embodiments of the present disclosure are set forth in the accompanying drawings and the description below. Other features and advantages of the present disclosure will be apparent from the description and drawings, and from the claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate examples of concepts that include the claimed invention and explain various principles and advantages of those examples.

FIG. 1 depicts an example system that includes a computer or computing device that can be programmed or otherwise configured to implement the systems and methods described herein.

FIG. 2 depicts an example environment that can be employed to execute the systems and methods described herein.

FIG. 3 depicts an example architecture that can be employed to execute the systems and methods described herein.

FIG. 4 depicts a flowchart of an example process for generating and then deploying software application code.

FIG. 5 depicts an example graphical user interface for defining a specification according to aspects of the present disclosure.

FIG. 6 depicts a flowchart of non-limiting processes for synthesizing software.

FIG. 7 depicts an example graphical user interface for defining a specification according to aspects of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples and aspects described and illustrated.

The apparatus and method components have been represented where appropriate by conventional symbols in the drawings, showing only those specific details that are pertinent to understanding the examples and aspects disclosed so as not to obscure the disclosure with details that will be readily apparent to those of ordinary skill in the art having the benefit of the description herein.

### DETAILED DESCRIPTION

Systems, methods, apparatus, and computer program products are provided that allow anyone, regardless of software development skills, to generate deploy-ready and trustworthy software applications just by describing them in natural language. Generally, the techniques disclosed herein are useful for ingesting a high-level user prompt and collaboratively building a detailed specification document (spec) in natural language that defines the functionality and scope of the user's desired software product. In some embodiments, the spec is built using an AI agent (the “Agent”) that “interviews” the user in an interactive question-answer process. In some embodiments, the Agent also lists assumptions made during synthesis for the user's review. The resulting spec is then used to generate deploy-ready software.

Because some users cannot understand or modify the code, the described system supports them through the entire software lifecycle: testing, modification, and maintenance. In some embodiments, the software-synthesizing system builds trust via multiple layers of interactive validation and verification (V&V) powered by a bidirectional mapping between the generated code and the contents of the spec that is established by the Agent when generating the software. The mapping allows the user and Agent to make changes to the spec that result in efficient changes to the generated software, thus enabling users to treat the spec as “source code” and to modify the software when desired. Finally, the mapping also enables users to understand exceptions and errors when they occur during runtime.

In some embodiments, the software-synthesizing system supports generating software with both frontend and backend components. Generally, the synthesized software fits into two high-level categories: one-time applications and recurring applications. Regardless of the type of application, the process of synthesizing software is the same and follows the same process of synthesis and verification.

In some embodiments, during synthesis, the Agent and the user collaborate to complete a specification document. For example, the document may start with an initial input from the user, detailing one or more requirements from the software application. The Agent then generates a draft specification document from this initial input, inserting details about the specific methodology used to implement the user's requirements The Agent then attempts to synthesize software from the document, which results in two outcomes: 1) either the Agent needs no further input and successfully synthesizes software, or 2) the Agent interacts with the user for further clarification. These interactions can take three forms: questions, assumption statements, and issues. The Agent solicits direct input from users by inserting “comments” into the document that users can interact with. Alternatively, users can highlight and comment on different sections of the document to challenge assumptions the Agent has made. The Agent then updates the document based on these comments. Generally, questions asked by the Agent solicit missing facts or knowledge. For example, “what time of day should the database records be moved?” or “how do I access the marketing campaign engagement data?” Generally, assumptions are statements about assumptions the Agent makes during synthesis, which can then be approved or disapproved by users. For example, “By database I assume you mean the ‘main-dB’ database.” Assumptions do not have to be explicit solicitations for interactions from the user. Any extra implementation detail that the Agent adds to the document is also considered an assumption. Generally, issues are brought to the user's attention if the specification cannot be compiled into software due to the existence of conflicting, contradictory, or impossible requirements.

As users answer questions, approve/disapprove assumptions, and resolve issues, new questions, assumption statements, and issues are brought up as necessary by the Agent. In some embodiments, these interactions are not sequentially linear like a chat session. Rather, the Agent may ask questions simultaneously about any user input in the document. Such inputs may lead to follow-on questions, resulting in a tree structure for the document where Agent-generated implementation details resulting from the user interaction may be indented under their respective user inputs. This back-and-forth takes the form of an “interview” where the Agent, through successive raising of questions and issues, tries to understand the user's requirements and helps them build a viable specification document.

Once all issues are resolved and questions answered, and if no assumptions are disapproved by the user, the Agent synthesizes software for the user. Because many users cannot write code, the software synthesizing software system guides them through a process designed to help establish trust in the generated software or make modifications to the specification as necessary. Whenever a question or issue is raised to the user, it signals to the user that the Agent again is not “hallucinating” the answer and is following a given logical sequence towards a solution.

Before disclosing the subject matter in greater detail, some context including terminology used herein is introduced.

### Definitions

As used herein, the term “synthesize” includes a process whereby a set of specification elements in a specification document are converted source code for a software application which, when run, implements those specifications.

As used herein, the term “one-time application” generally includes software that performs an action(s) and then terminates. For example, an application that provides batch communication, or cleans up specific records from a database.

As used herein, the term “recurring application” generally includes software that executes continuously until the user ends the runtime. Examples include integration scripts that listen to events and take actions under specific conditions, or web/desktop/mobile apps that run until the user exits them, or backend applications that run continuously and perform automated actions.

As used herein, the term “natural language” generally includes language that has developed in the usual way as a method of communicating between people, rather than language that has been created, for example, for computers.

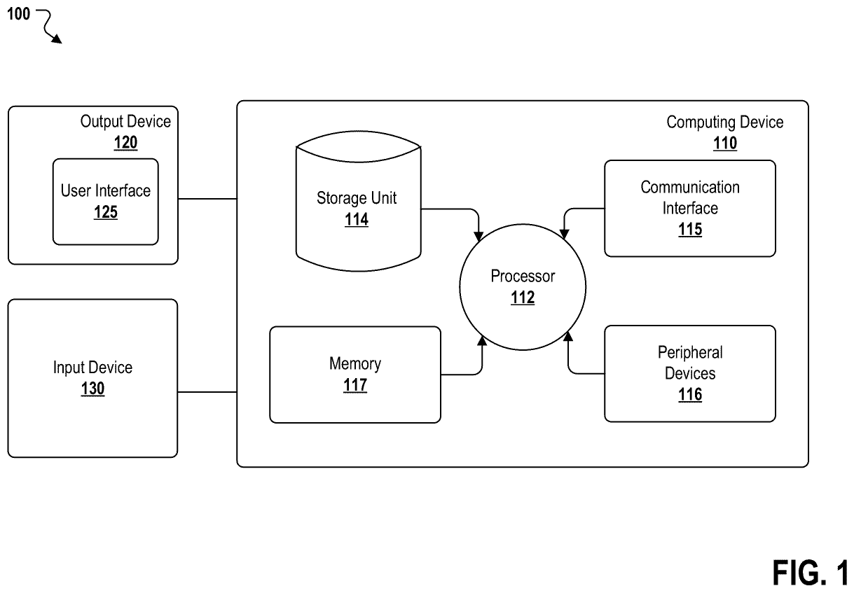

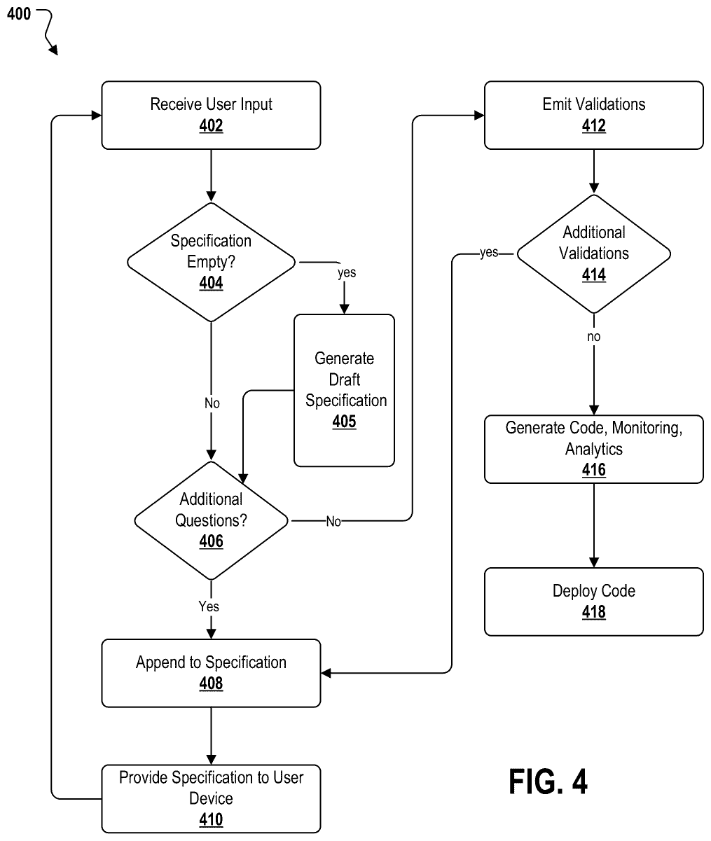

FIG. 1 depicts an example of a system 100 that includes a computer or computing device 110 that can be programmed or otherwise configured to implement systems or methods of the present disclosure. For example, the computing device 110 can be programmed or otherwise configured to implement a software-synthesizing system as well as the process 400 described below with reference to FIG. 4.

The computer or computing device 110 includes an electronic processor (also “central processing unit” (CPU), “processor,” and “computer processor” herein) 112, which is optionally a single core, a multi core processor, or a plurality of processors for parallel processing. The depicted embodiment also includes memory 117 (e.g., random-access memory, read-only memory, flash memory), electronic storage unit 114 (e.g., hard disk or flash), communication interface 115 (e.g., a network adapter or modem) for communicating with one or more other systems, and peripheral devices 116, such as cache, other memory, data storage, microphones, speakers, and the like. In some embodiments, the memory 117, storage unit 114, communication interface 115 and peripheral devices 116 are in communication with the electronic processor 112 through a communication bus (shown as solid lines), such as a motherboard. In some embodiments, the bus of the computing device 110 includes multiple buses. In some embodiments, the computing device 110 includes more or fewer components than those illustrated in FIG. 1 and performs functions other than those described herein.

In some embodiments, the memory 117 and storage unit 114 include one or more physical apparatuses used to store data or programs on a temporary or permanent basis. In some embodiments, the memory 117 is volatile memory and requires power to maintain stored information. In some embodiments, the storage unit 114 is non-volatile memory and retains stored information when the computer is not powered. In further embodiments, memory 117 or storage unit 114 is a combination of devices such as those disclosed herein. In some embodiments, memory 117 or storage unit 114 is distributed across multiple machines such as a network-based memory or memory in multiple machines performing the operations of the computing device 110.

In some cases, the storage unit 114 is a data storage unit or data store for storing data. In some instances, the storage unit 114 stores files, such as drivers, libraries, and saved programs. In some embodiments, the storage unit 114 stores user data (e.g., user preferences and user programs). In some embodiments, the computing device 110 includes one or more additional data storage units that are external, such as being located on a remote server that is in communication through an intranet or the internet.

In some embodiments, methods as described herein (e.g., process 400 described in FIG. 4) are implemented by way of machine or computer executable code stored on an electronic storage location of the computing device 110, such as, for example, on the memory 117 or the storage unit 114. In some embodiments, the electronic processor 112 is configured to execute the code. In some embodiments, the machine executable or machine-readable code is provided in the form of software. In some cases, the code is retrieved from the storage unit 114 and stored on the memory 117 for ready access by the electronic processor 112.

The electronic processor 112 is configured to perform various operations, such as fetching, decoding, executing, and writing back, and the like. In some cases, the electronic processor 112 is a component of a circuit, such as an integrated circuit. One or more other components of the computing device 110 can be optionally included in the circuit. In some cases, the circuit is an application specific integrated circuit (ASIC) or a field programmable gate array (FPGA). In some cases, the operations of the electronic processor 112 can be distributed across multiple machines (where individual machines can have one or more processors) that can be coupled directly or across a network.

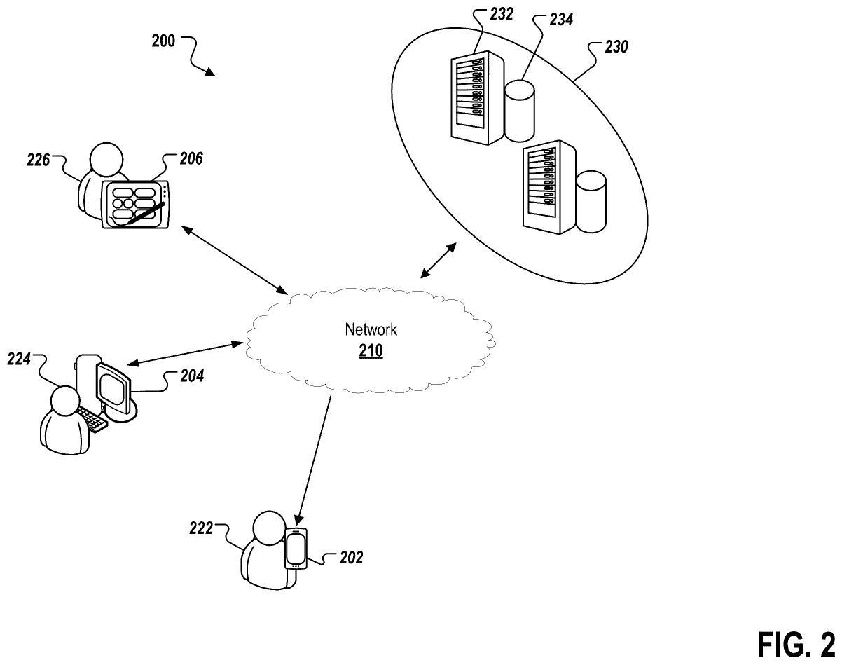

With reference to FIG. 2, in some embodiments, the computing device 110 is optionally operatively coupled to a communication network, such as a network 210 via the communication interface 115. In some embodiments, the computing device 110 communicates with one or more remote computer systems through the network 210. In some embodiments, a user can access the computing device 110 via the network 210. In some embodiments, the computing device 110 is configured as a node within a peer-to-peer network.

With continued reference to FIG. 1, in some embodiments, the computing device 110 includes or is in communication with one or more output devices 120. In some embodiments, the output device 120 includes a display to send visual information to a user. In some embodiments, the output device 120 is a touch sensitive display that combines a display with a touch sensitive element that is operable to sense touch inputs as and functions as both the output device 120 and the input device 130. In still further embodiments, the output device 120 is a combination of devices such as those disclosed herein. In some embodiments, the output device 120 displays a user interface 125 generated by the computing device (e.g., software executed by the computing device 110).

In some embodiments, the computing device 110 includes or is in communication with one or more input devices 130 that are configured to receive information from a user. In some embodiments, the input device 130 is a keyboard. In some embodiments, the input device 130 is a keypad (e.g., a telephone-based keypad). In some embodiments, the input device 130 is a cursor-control device including, by way of non-limiting examples, a mouse, trackball, trackpad, joystick, game controller, or stylus. In some embodiments, as described above, the input device 130 is a touchscreen or a multi-touchscreen. In other embodiments, the input device 130 is a microphone to capture voice or other sound input. In other embodiments, the input device 130 is a camera or video camera. In still further embodiments, the input device is a combination of devices such as those disclosed herein.

In some embodiments, the computing device 110 includes an operating system configured to perform executable instructions. The operating system is, for example, software, including programs and data that manages the hardware of the device and provides services for execution of applications.

With reference to FIG. 2, the computing device 110 may be embodied in an electronic device 202, 204, and 206, which can include, for example, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. The electronic devices 202, 204, 206 can communicate to a back-end system 230 via a communication network 210.

Three electronic devices 202, 204, and 206 are depicted in FIG. 2 for simplicity. As illustrated, the electronic device 202 is depicted as a smartphone, the electronic device 204 is depicted as a tablet-computing device, and the electronic device 206 is depicted as a desktop computing device. It is contemplated, however, that embodiments of the present disclosure can be realized with any suitable computing devices, such as those mentioned previously and the like. Moreover, embodiments of the present disclosure can employ any number of devices.

In some examples, users 222, 224, and 226 of the electronic devices 202, 204, and 206 interact with the system through a graphical user interface (GUI) (e.g., the user interface 125) or an application that is installed and executed on their respective electronic devices 202, 204, and 206. In some examples, the electronic devices 202, 204, and 206 provide viewing data to screens with which the users 222, 224, and 226, can interact.

The communication network 210 may include wireless and wired portions. In some embodiments, the communication network 210 is implemented using one or more existing networks, for example, a cellular network, the Internet, a land mobile radio (LMR) network, a Bluetooth™ network, a wireless local area network (e.g., Wi-Fi), a wireless accessory Personal Area Network (PAN), a Machine-to-machine (M2M) network, and a public switched telephone network. The communication network 210 may also include future developed networks. In some embodiments, the communication network 210 includes the Internet, an intranet, an extranet, or an intranet and/or extranet that is in communication with the Internet. In some embodiments, the communication network 210 includes a telecommunication or a data network.

In some embodiments, the communication network 210 connects web sites, devices (e.g., the electronic devices 202, 204, and 206) and back-end systems (e.g., the back-end system 230). In some embodiments, the communication network 210 can be accessed over a wired or a wireless communications link. For example, mobile computing devices (e.g., the smartphone device 202 and the tablet device 206), can use a cellular network to access the communication network 210.

In some embodiments, the back-end system 230 includes at least one server 232 and at least one data store 234. In some embodiments, the server 232 is sustainably similar to device 110 depicted in FIG. 2. In some embodiments, the server 232 is a server-class hardware type device. In some embodiments, the back-end system 230 includes computer systems using clustered computers and components to function as a single pool of seamless resources when accessed through the communications network 210. For example, such embodiments may be used in data center, cloud computing, storage area network (SAN), and network attached storage (NAS) applications. In some embodiments, the back-end system 230 is deployed using a virtual machine(s).

In some embodiments, the data store 234 is a repository for persistently storing and managing collections of data. Example data stores that may be employed within the described system include data repositories, such as a database as well as simpler store types, such as files, emails, and so forth. In some embodiments, the data store 234 includes a database. In some embodiments, a database is a series of bytes or an organized collection of data that is managed by a database management system (DBMS).

In some embodiments, the back-end system 230 hosts one or more computer-implemented services provided by the described system with which users 222, 224, and 226 can interact using the respective electronic devices 202, 204, and 206. For example, in some embodiments, the back-end system 230 is configured to receive an initial prompt from one of the electronic devices 202, 204, or 206. In some embodiments, the initial prompt includes a natural language description of a plurality of specification elements defining a functionality and a scope of a software application. In some embodiments, the back-end system 230 processes the initial prompt through a synthesis model to synthesize software application code for the software application. In some embodiments, the back-end system 230 deploys the generated software application code to a deployment platform for execution. In some embodiments, the back-end system 230 provides prompts for clarification or a modification to the specification document to correct a runtime error to the electronic devices 202, 204, and 206. In some embodiments, the back-end system 230 trains/retrains the synthesis model. In some embodiments, the back-end system 230 is configured as a deployment platform that hosts software application code generated by the software-synthesizing system.

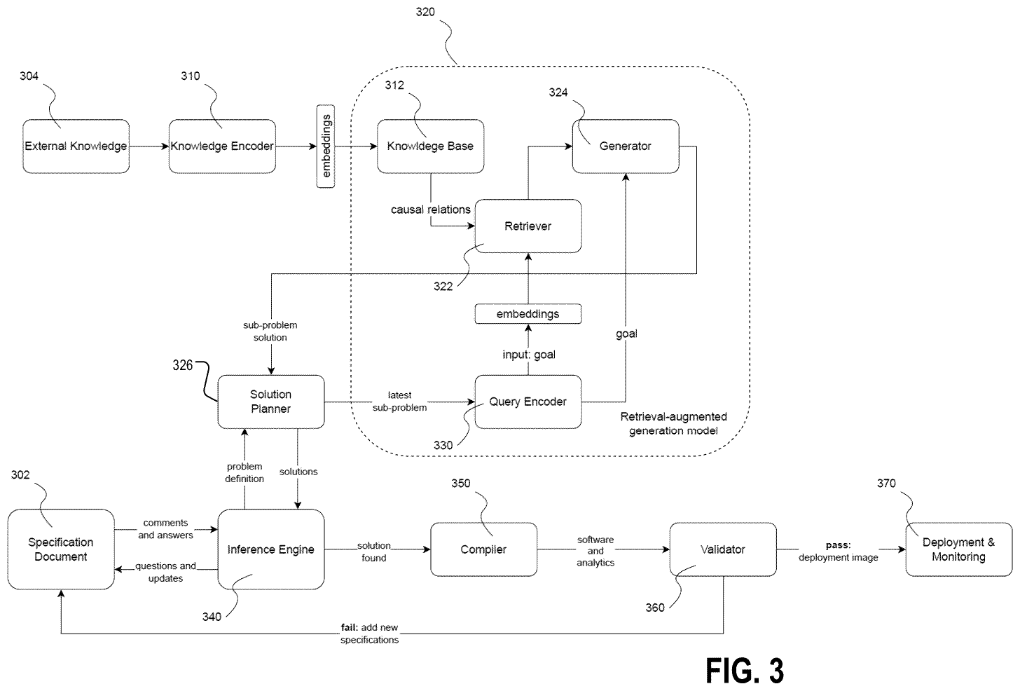

FIG. 3 depicts an example architecture 300 of the software-synthesizing system. As depicted, the example architecture 300 include specification document 302, external knowledge base 304, knowledge encoder model 310, synthesis model 320, retriever model 322, generator model 324, knowledge base 312, query encoder model 330, inference engine 340, compiler module 350, validator module 360, and monitoring module 370.

Generally, the specification document 302 includes the specification elements resulting from the combination of the initial prompt, clarifying questions by the Agent, assumption statements by the Agent, the resulting user answers and inputs, and the like. The specification elements contained within the specification document 302 are one end of the bidirectional mapping between specification and synthesized software. The Agent may add new elements to the document, for example, clarifying questions or assumption statements, depending on the state of the synthesis.

Generally, the external knowledge base 304 includes the causal relationships and known facts that are used by the Agent to process the specification elements into output fragments. These output fragments may be combinations of software application code fragments, as well as logical specifications denoting questions, assumptions, issues, or as-yet unresolved constraints that will be resolved in future iterations of the core loop, The Agent may use one or more elements within the external knowledge base 304 when processing a specification element. The knowledge elements inside the external knowledge base 304 may be common to all users, or specific to a single user or organization.

Generally, the knowledge encoder model 310 processes the external knowledge base 304 elements into a continuous vector representation which permits the retriever to select the most appropriate elements of external knowledge base 304 for processing specification elements. In some embodiments, the encoder is a custom-trained transformer-based machine learning model that is trained to minimize a vector distance measure of similarity between external knowledge base 304 elements, which include causal relations and known facts, and their respective specification elements. The custom uses synthetic data comprising specification elements and external knowledge elements. The knowledge encoder model 310 is trained to minimize the vector distance between the embeddings it generates for an external knowledge element and the embedding the query encoder model 330 generates for a specification element, in the case that the analogy between the two is logical and should be successful by the generator model 324.

Generally, the knowledge base 312 includes elements that are mappings between external knowledge base 304 elements and their continuous vector representations as computed by the encoder model 310. This mapping permits fast lookup of external knowledge base 304 elements relevant to a particular specification element.

Generally, the query encoder model 330 is a custom-trained transformer-based machine-learning model trained in tandem with the encoder model 310 to minimize the continuous vector distance between specification elements and relevant knowledge base 312 elements, where relevant means the specification element and knowledge base element should be successfully analogized by the generator model 324. Similar to the knowledge encoder model 310, the custom training for this model uses synthetic data comprising specification elements and external knowledge elements. The query encoder model 330 is trained to minimize the vector distance between the embeddings it generates for a specification element and the embedding the knowledge encoder model 310 generates for an external knowledge element, in the case that the analogy between the two is logical and should be successful by the generator model 324.

Generally, the retriever model 322 retrieves and ranks knowledge (e.g., in the form of causal relationships and facts) from the external knowledge base 312 that is relevant to a given specification element. In some embodiments, the model uses the query encoder model 330 to rank a number of relevant causal relationships or facts from the knowledge base 312.

Generally, the generator model 324 is a custom-trained transformer-based machine learning model configured to ingest the specification element and related retrieved knowledge provided by the retriever model 322 and generate a sub-problem solution, which may include software code or representations of logical constraints, the latter which may lead to further clarifying questions to the user, statements of assumptions, or issues. The generator model 324 is trained with synthetic data to take a specification element and a causal relation from the knowledge base, and “analogize” the specification element to the causal relation, producing either an analogized output, or an error signal. The synthetic training data are triplets of specification elements, causal relations, and analogized outputs. The generator model 324 is also trained to generate explicit signals that a required input to the causal relationship is missing from the specification element. This is then used by the planner 326 to generate questions for users.

The solution planner 326 receives the sub-solution problem from the generator model 324. The solution planner 326 simultaneously tracks one or more solution candidates and numeric scores that indicate their ordering from best to worst. At each iteration, the planner takes or more solution candidates from the search “frontier”, and provides their latest sub-problem to the synthesis model 320. If the synthesis model 320 returns a viable sub-problem solution, then it is incorporated into the solution candidate and the solution planner 326 updates the numeric score for the candidate. If a candidate has no more sub-problems outstanding, it becomes a solution which is returned to the inference engine 340.

Generally, the inference engine 340 is the organizing core of the synthesis operation. In some embodiments, the inference engine 340 uses the retriever model 322, generator model 324, and the solution planner 326, as well as a custom symbolic solver to ensure that the output fragments are logically consistent and result in executable and correct code when combined. In some embodiments, the symbolic solver uses the solutions and sub-problem solutions (e.g., output code and constraints) generated by the solution planner 326 to form clarifying questions when needed, emit assumption statements, or raise issues when logical inconsistencies or software issues are encountered during synthesis.

In some embodiments, the synthesis model 320 refers collectively to the knowledge base 312, retriever model 322, generator model 324, query encoder model 330, and inference engine 340. Training the synthesis model 320 refers to training the individual machine learning models of its constituents. In some embodiments, the synthesis model 320 functions by running a core loop, taking unprocessed specification elements from the specification document 302, passing them to the inference engine 340 which subsequently coordinates the retriever model 322, and generator model 324, to synthesize a fragment of the output, potentially including the definitions of further questions, assumptions, and issues. In some embodiments, the synthesis model 320 runs this core loop until no issues or unanswered clarifying questions remain in the specification document 302, at which point the output is processed by the compiler module 350 to generate a deployable software application.

Generally, the compiler module 350 takes the collection of the output fragments generated by the synthesis model 320, which include code fragments and logical constraints, and compiles it into functional code in a target programming language compatible with the deployment platform. The result is code which can be immediately deployed to run the synthesized program.

Generally, the validator module 360 generates validation scenarios that are analogous to high-level ‘unit tests’ that the user may approve/disapprove. In some embodiments, the validation scenarios are constructed from the logical constraints output by the synthesis model 320. Each validation scenario will present the user with a scenario, for example “tomorrow morning at 8 am, if Alice and Bob have not heard back from us, I will notify the hiring manager.” The user may approve the scenario, or disapprove the scenario and be guided back to the specification document 302 to amend the specification and correct the undesired program functionality. The validator module 360 may also inject code necessary to enable supervision of critical actions by the user to guardrail the application until the user has built trust in its operation.

In some embodiments, the validator module 370 presents the user with hypothetical scenarios that are used to validate the function of the synthesized software application code. If any errors are detected by the user, the spec document can be modified to re-synthesize the program. The validator module 370 may also include other steps to allow users to gradually remove guardrails from generated programs as more trust is established in their functionality. For example, the validator may stop execution of the program at certain user-elected actions which could be critical or irreversible, asking the user to “supervise” them. The user can elect to either a) approve the action to be taken once, b) disapprove the action, at which point execution will terminate and the user will be directed to the specification document to amend it, or c) approve the action and futures ones that are similar.

Generally, the deployment and monitoring module 370 provides functions that enable the synthesized program output by the compiler module 350 to run on a cloud-based deployment platform. In some cases, the deployment and monitoring module 370 also provides functionality required to monitor the execution of running programs, including the state of execution, notification of errors, or supervision of actions as part of validation.

FIG. 4 depicts a flowchart of an example process 400 for generating and deploying software application code determined based on an initial prompt and subsequent answers to interview questions provided by a user. The example process 400 can be implemented by the components of the example environment described above with respect to FIG. 2 and is described with reference to the elements of the example architecture 300 described above with respect to FIG. 3. However, it will be understood that the process 400 may be performed, for example, by any other suitable system, environment, software, and hardware, or a combination of systems, environments, software, and hardware as appropriate. In some embodiments, various operations of the process 400 can be run in parallel, in combination, in loops, or in any order.

At 402, an initial prompt is received from a user device and provided to the synthesis model 320. At block 404, if the specification is empty (i.e., a draft specification has not been already generated, the process 400 proceeds to 405 where the synthesis model 320 synthesizes the specification document 302 based on the initial prompt. Where, at block 404, the specification is empty (e.g., this is the first time the process 400 is iterating), the synthesis process begins at block 406 (as described below).

From 405, the process 400 proceeds to block 406 where the synthesis model 320 determines whether the synthesizes was successful without the need for further clarifying questions by, as described above with reference to FIG. 3, running the core loop, taking unprocessed specification elements from the specification document 302, passing them to the inference engine 340 which subsequently coordinates the retriever model 322, generator model 324, and solution planner 326 to synthesize a fragment of the output. If unanswered questions, unapproved assumptions, or unresolved issues exist, the process 400 proceeds to 408. At 408, the synthesis model 320 appended these further questions, assumptions, and issues to the specification document 302. From 408, the process 400, proceeds to 410 where the specification document 302, which includes the questions, assumptions, and issues, is provided to the user device. From 410, the process 400 proceeds back to 402 where the user input related to the updated specification document 302 (e.g., answers to the provided questions, assumptions, and issues) is received.

The synthesis model 320 runs the core loop of steps 402 through steps 410 until no issues or unanswered clarifying questions remain in the specification document 302 (at block 406). When the specification document 302 is determined as successfully generated (e.g., no unanswered questions, disapproved assumptions, and outstanding issues remain), the process 400 proceeds, from block 406, to 412 where validator module 360 generates validation scenarios that are analogous to high-level ‘unit tests’ based on the specification document 302 and then to 414, where the software application code necessary for supervision of critical actions generated by the validator module 360 are added to the output code.

The loop 402-414 is executed until no more questions and issues remain and, and no assumptions are disapproved by the user. At 416, the specification document 302 (and output fragments) are provided to the compiler module 350. The compiler module 350 compiles the collection of the output fragments into functional code in a target programming language compatible with a deployment platform. From 416, the process 400 proceeds to 418 when the code is deployed in the target environment.

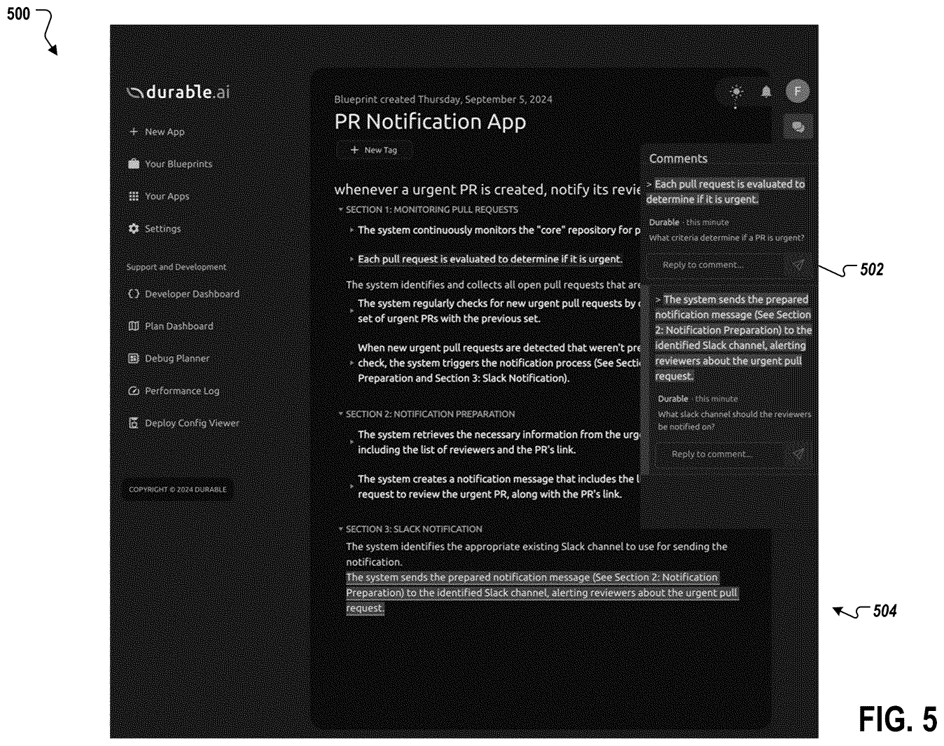

FIG. 5 depicts a screen 500 showing an example process of defining a specification according to aspects of the present disclosure. In some aspects, as illustrated in FIG. 5, the graphical user interface to the system resembles a document with section headings and logical organization. Users request modifications by highlighting text and adding a comment for the Agent (e.g., for a local change), or adding comments concerning the document as a whole (e.g., for a global change). As described below and illustrated in FIG. 5, the Agent poses questions to users by highlighting text and creating a comment. This method mirrors how documents are used in practice, making for a more familiar and consistent user interface.

In the illustrated example, a PR (pull request) notification app is being developed. In the depicted example, the initial prompt (in this case “whenever an urgent PR is created, notify its reviewer”) marks the beginning of the document tree. The Agent presents the user with questions designed to solicit relevant user input (e.g., missing knowledge, facts, or to select from a number of possible options). In the illustrated example, in chat session 502, the Agent-generated questions are posed to the user as comments in the document. The Agent may also present assumptions made during synthesis to the user for approval or disapproval. The user's answers and choices then become part of the specification and may result in further questions. For example, passage 504, provided by the user in the chat session 502, has been added to the specification and highlighted. Once no more questions remain, and if there are no outstanding issues in the spec, software application code can be synthesized.

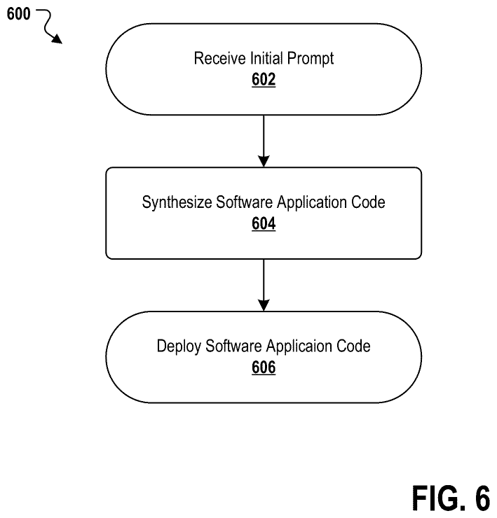

FIG. 6 depicts a flowchart of an example process 600. The example process 600 generally shows in more detail how an Agent interacts with a user to synthesize software. For clarity of presentation, the description that follows generally describes the example process 600 in the context of FIGS. 1-5. For example, the example process 600 can be implemented by the components of the example environment described above with respect to FIG. 2 and the example architecture described above with respect to FIG. 3. Relevant output may be provided to a user via the user interface 125 associated with the electronic device 202, 204, or 206. However, it will be understood that the process 600 may be performed by any other suitable system, environment, software, and hardware, or a combination of systems, environments, software, and hardware as appropriate. In some embodiments, various operations of the process 600 can be run in parallel, in combination, in loops, or in any order.

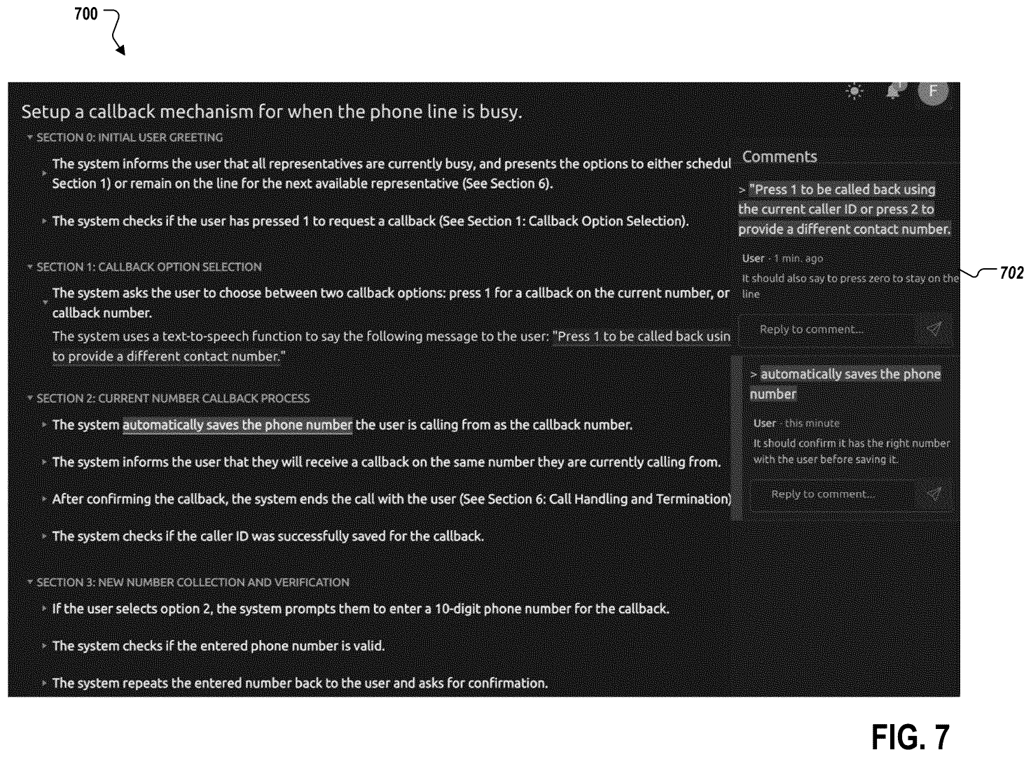

At 602, an initial prompt is received from a user device (e.g., the electronic devices 202, 204, and 206). The initial prompt (e.g., as illustrated in FIG. 7, “Setup a callback mechanism for when the phone line is busy.”) includes a natural language description of a plurality of specification elements defining a functionality and a scope of a software application. In some embodiments, the software application includes frontend components and backend components.

From 602 the process 600 proceeds to 604 where software application code for the software application is synthesized by processing the initial prompt through a synthesis model. The synthesis model is trained to generate, based on the initial prompt, a specification document that includes the specification elements; and generate the software application code for the software application by determining a bidirectional mapping between the software application code and the specification elements. In some embodiments, the specification elements are provided in natural language in the specification document.

In some embodiments, the synthesis model is trained to generate the specification document by: providing, to the user device, a prompt for clarification generated by processing the initial prompt through the synthesis model; updating the specification document by processing an answer to the prompt for clarification, received from the user device, through the synthesis model. For example, as illustrated in the example graphical user interface 700 of FIG. 7, a chat session 702 shows the system prompting the user and receiving user feedback. In some embodiments, the answer to the prompt for clarification includes a missing fact regarding the software application. In some embodiments, the answer to the prompt for clarification includes an approval or disapproval of a statement of assumption. In some embodiments, the prompt for clarification includes a statement of an assumption provided by the synthesis model. In some embodiments, the prompt for clarification includes a conflicting requirement, a contradictory requirement, or an impossible requirement. In some embodiments, the answer to the prompt for clarification includes a resolution for the conflicting requirement, the contradictory requirement, or the impossible requirement.

In some embodiments, the synthesis model is trained using a supervised learning loss function that rewards a correct use of knowledge base entries, stored to a knowledge base, given the context of a synthesis problem and specification elements being considered. In some embodiments, the initial prompt and the answer to the prompt for clarification is stored to the knowledge base as knowledge base entries.

In some embodiments, a modification to the initial prompt or any of the clarifying answers within the specification document is received from the user device. In some embodiments, the synthesis model is trained to update the synthesized software application based on the modification or alternatively emit further clarifying questions, statements of assumptions, or issues.

In some embodiments, the synthesis model includes a retriever model and a generator model that are trained with synthetic data spanning the domains of natural language with an internal representation. In some embodiments, this training data allows these models to retrieve causal relationships from the knowledge base, then apply them to the specification elements to advance the state of the synthesis. In some embodiments, the synthesis model is retrained with the initial prompt, the specification document, or the software application code. In some embodiments, the synthesis model includes a trained AI model. In some embodiments, the synthesis model includes a trained neural network.

From 604 the process 600 proceeds to 606 where the generated software application code is deployed to a deployment platform (e.g., provided by the back-end system 230) for execution. In some embodiments, a plurality of validation scenarios to assess a correctness of the generated software application code is provided to the user device, a rejections of one or more of the validation scenarios is received from the user device, and a prompt to modify the specification document based on the one or more rejected validation scenarios is provided to the user device.

In some embodiments, a runtime error generated during execution of the software application code is received from the deployment platform, a modification to the specification document to correct the runtime error is determined based on the bidirectional mapping, and a prompt for the modification is provided to the user device.

In some embodiments, the software application code is configured to, when executed by the deployment platform, perform at least one action, and then terminate. In some embodiments, the software application code is configured to, when executed by the deployment platform, continuously perform at least one action.

In some embodiments, a request to supervise an execution of a step related to at least one of the specification elements is received from the user device, before deploying the generated software application code to the deployment platform, the request is integrated into the software application code, a prompt for supervising of the step received from the deployment platform during execution of the software application code is provided to the user device, and a supervision instruction related to the step received from the user device is provided to the deployment platform in response to the prompt for approving or rejecting the step. In some embodiments, the step is determined according to the bidirectional mapping. In some embodiments, a prompt to modify the specification document is provided to the user device when the supervision instruction includes rejecting of the step.

### Non-transitory Computer Readable Storage Medium

In some embodiments, the platforms, systems, media, and methods disclosed herein include one or more non-transitory computer readable storage media encoded with a program including instructions executable by the operating system of an optionally networked computer. In further embodiments, a computer readable storage medium is a tangible component of a computer. In still further embodiments, a computer readable storage medium is optionally removable from a computer. In some embodiments, a computer readable storage medium includes, by way of non-limiting examples, compact disc read-only memories (CD-ROMs), digital versatile discs (DVDs), flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the electronic processor (e.g., CPU) of the computer, written to perform a specified task. Computer readable instructions may be implemented as program modules, such as functions, objects, API, data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Machine Learning

In some embodiments, machine learning algorithms are employed to build a model to synthesize software application code for a software application based on an initial prompt provided by a user. Examples of machine learning algorithms may include a support vector machine (SVM), a naïve Bayes classification, a random forest, a neural network, deep learning, or other supervised learning algorithm or unsupervised learning algorithm for classification and regression. The machine learning algorithms may be trained using one or more training datasets. For example, previously received digital profile data may be employed to train various algorithms. Moreover, as described above, these algorithms can be continuously trained/retrained using real-time user data as it is received. In some embodiments, the machine learning algorithm employs regression modeling where relationships between variables are determined and weighted. In some embodiments, the machine learning algorithm employs regression modeling where relationships between predictor variables and dependent variables are determined and weighted.

### Web Application

In some embodiments, a computer program includes a web application. A web application refers to an application software that runs on a web server, unlike computer-based software programs that are run locally on the operating system of the device. The web application is accessed by a user through a web browser with an active network connection. A part of the web application may run on a remote server and another part may run on a client device usually inside a web browser and both parts may communicate over a computer network, for example the internet. In some embodiments, a web application is created using a software framework such as Microsoft®.NET or Ruby on Rails (RoR). In some embodiments, a web application employs one or more database systems including, by way of non-limiting examples, relational, non-relational, object oriented, associative, and extensible Markup Language (XML) database systems. In further embodiments, suitable relational database systems include, by way of non-limiting examples, Microsoft® SQL Server, mySQL™, and Oracle®. A web application may be written in one or more markup languages, presentation definition languages, client-side scripting languages, server-side coding languages, database query languages, or combinations thereof.

### Mobile Application

In some embodiments, a computer program includes a mobile application provided to a mobile device. In some embodiments, the mobile application is provided to a mobile device at the time it is manufactured. In other embodiments, the mobile application is provided to a mobile computer via the computer network described herein. A mobile application is created by techniques known to those of skill in the art using hardware, languages, and development environments known to the art. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

### Standalone Application

In some embodiments, a computer program includes a standalone application, which is a program that is run as an independent computer process, not an add-on to an existing process, (e.g., not a plug-in). Standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable compiled applications.

### Software Modules

In some embodiments, the systems and methods disclosed herein include software, server, or database modules. Software modules are created using machines, software, and languages. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Data Stores

In some embodiments, the platforms, systems, media, and methods disclosed herein include one or more data stores. Data stores include repositories for persistently storing and managing collections of data. Types of data stores repositories include, for example, databases and simpler store types, or use of the same. Simpler store types include files, emails, and so forth. In some embodiments, a database is a series of bytes that is managed by a DBMS. In various embodiments, suitable databases include, by way of non-limiting examples, relational databases, non-relational databases, object-oriented databases, object databases, entity-relationship model databases, associative databases, and XML databases. Further non-limiting examples include SQL, PostgreSQL, MySQL, Oracle, DB2, and Sybase. In some embodiments, a database is cloud computing based.

### Other Definitions

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. As used in this specification and the appended claims, the singular forms “a,” “an,” and “the” include plural references unless the context clearly dictates otherwise. Any reference to “or” herein is intended to encompass “and/or” unless otherwise stated.

The term “approximately” as used herein refers to any values, including both integers and fractional components that are within a variation of up to +10% of the value modified by the term “about.” In certain aspects, the term “approximately” refers to a range of values that fall within 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). Alternatively, “approximately” can mean within 3 or more than 3 standard deviations, per the practice in the art.

It is understood that the foregoing detailed description and accompanying examples are merely illustrative and are not to be taken as limitations upon the scope of the invention.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112 (f) interpretations as “means-plus-function” language unless specifically expressed as such by use of the words “means for” or “steps for” within the respective claim.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example embodiments does not define or constrain this disclosure. Other changes, substitutions, and alterations are also possible without departing from the spirit and scope of this disclosure.

What is claimed is:

1. A method for synthesizing software application code for a software application, the method comprising:
receiving, from a user device, an initial prompt comprising a natural language description of a plurality of specification elements defining a functionality and a scope of a software application;
synthesizing software application code for the software application by processing the initial prompt through a synthesis model, wherein the synthesis model is trained to:
generate, based on the initial prompt, a specification document comprising the plurality of specification elements; and
generate the software application code for the software application by determining a bidirectional mapping between the software application code and the plurality of specification elements; and
deploying, to a deployment platform, the software application code for execution.

2. The method of claim 1, wherein the synthesis model is trained to generate the specification document by:
providing, to the user device, a prompt for clarification generated by processing the initial prompt through the synthesis model; and
updating the specification document by processing an answer to the prompt for clarification, received from the user device, through the synthesis model.

3. The method of claim 2, wherein the answer to the prompt for clarification includes a missing fact regarding the software application.

4. The method of claim 2, wherein the answer to the prompt for clarification includes an approval or disapproval of a statement of assumption.

5. The method of claim 2, wherein the prompt for clarification includes a statement of an assumption provided by the synthesis model.

6. The method of claim 2, wherein the prompt for clarification includes a conflicting requirement, a contradictory requirement, or an impossible requirement.

7. The method of claim 6, wherein the answer to the prompt for clarification includes a resolution for the conflicting requirement, the contradictory requirement, or the impossible requirement.

8. The method of claim 1, wherein the synthesis model is trained using a supervised learning loss function that rewards a correct use of knowledge base entries, stored to a knowledge base, given a context of a synthesis problem and the plurality of specification elements being considered.

9. The method of claim 8, further comprising:
storing the initial prompt and an answer to a prompt for clarification to the knowledge base as knowledge base entries.

10. The method of claim 1, further comprising:
providing, to the user device, a plurality of validation scenarios to assess a correctness of the software application code;
receiving, from the user device, one or more rejections of one or more of the plurality of validation scenarios; and
providing, to the user device, a prompt to modify the specification document based on the one or more rejections of one or more of the plurality of validation scenarios.

11. The method of claim 1, further comprising:
receiving, from the user device, a modification to the initial prompt or an answer to a prompt for clarification within the specification document.

12. The method of claim 11, wherein the synthesis model is trained to update the software application code based on the modification or alternatively emit further clarifying questions, statements of assumptions, or issues.

13. The method of claim 1, further comprising:
receiving, from the deployment platform, a runtime error generated during the execution of the software application code;
determining, based on the bidirectional mapping, a modification to the specification document to correct the runtime error; and
providing a prompt for the modification to the user device.

14. The method of claim 1, wherein the software application comprises frontend components and backend components.

15. The method of claim 1, wherein the software application code is configured to, when executed by the deployment platform, perform at least one action, and then terminate.

16. The method of claim 1, wherein the software application code is configured to, when executed by the deployment platform, continuously perform at least one action.

17. The method of claim 1, wherein the synthesis model comprises a retriever model and a generator model that are trained with synthetic data spanning domains of natural language with an internal representation.

18. The method of claim 1, further comprising:
retraining the synthesis model with the initial prompt, the specification document, or the software application code.

19. The method of claim 1, wherein the synthesis model comprises a trained artificial intelligence (AI) model.

20. The method of claim 19, wherein the synthesis model comprises a trained neural network.

21. The method of claim 1, wherein the plurality of specification elements are provided in natural language in the specification document.

22. The method of claim 1, further comprising:
receiving, from the user device, a request to supervise an execution of a step related to at least one of the plurality of specification elements, wherein the step is determined according to the bidirectional mapping;
before deploying the software application code to the deployment platform, integrating the request into the software application code;
providing, to the user device, a prompt for supervising of the step received from the deployment platform during the execution of the software application code; and
providing, to the deployment platform, a supervision instruction related to the step received from the user device in response to the prompt for approving or rejecting the step.

23. The method of claim 22, further comprising:
providing, to the user device, a prompt to modify the specification document when the supervision instruction includes rejecting of the step.

24. A system for synthesizing software application code for a software application, the system comprising:
a user device;
a deployment platform; and
an electronic processor configured to:
receive, from the user device, an initial prompt comprising a natural language description of a plurality of specification elements defining a functionality and a scope of a software application;
synthesize software application code for the software application by processing the initial prompt through a synthesis model, wherein the synthesis model is trained to:
generate, based on the initial prompt, a specification document comprising the plurality of specification elements; and
generate the software application code for the software application by determining a bidirectional mapping between the software application code and the plurality of specification elements; and
deploying, to the deployment platform, the software application code for execution.

25. A non-transitory computer readable medium having stored thereon executable instructions that, when executed by an electronic processor, cause the electronic processor to perform operations comprising:
receiving, from a user device, an initial prompt comprising a natural language description of a plurality of specification elements defining a functionality and a scope of a software application;
synthesizing software application code for the software application by processing the initial prompt through a synthesis model, wherein the synthesis model is trained to:
generate, based on the initial prompt, a specification document comprising the plurality of specification elements; and
generate the software application code for the software application by determining a bidirectional mapping between the software application code and the plurality of specification elements; and
deploying, to a deployment platform, the software application code for execution.
